(19) United States
(12) Patent Application Publication
(10) Pub. No.: US 2009/0148172 A1
(43) Pub. Date: Jun. 11, 2009

(54) DRAWING DEVICE, EXPOSURE DEVICE, AND DRAWING METHOD

(75) Inventors: Takashi Fukui, Kanagawa (JP); Mitsuru Mushano, Kanagawa (JP); Daisuke Nakaya, Kanagawa (JP)

Correspondence Address: YOUNG & THOMPSON, 209 Madison Street, Suite 500, ALEXANDRIA, VA, 22314, US

(73) Assignee: FUJIFILM CORPORATION, TOKYO (JP)

(21) Appl. No.: 12/063,235

(22) PCT Filed: Aug. 11, 2006
(86) PCT No.: PCT/JP2006/315941

§ 371 Date: Feb. 8, 2008

(30) Foreign Application Priority Data
Aug. 15, 2005 (JP) 2005-235554

(51) Int. Cl. G03G 15/04

(52) U.S. Cl. 399/32

(57) ABSTRACT

The present invention provides a drawing device. A drawing component includes a stage and a drawing head. The drawing head draws on a recording medium supported by the stage. A moving component relatively moves the stage and the drawing head. A position detection component detects a relative position of the stage and the drawing head. An error detection component detects an abnormal state in which an abnormal drawing is performed on the recording medium. When the abnormal state is detected, a controller stops drawing with the drawing head and returns the relative position from the stop position to the position of the drawing start side, so that drawing may be resumed from a position within a predetermined range including the stop position.

### TECHNICAL FIELD

The present invention relates to a drawing device which includes a stage and a drawing head arranged so as to be relatively movable and performs drawing on a recording medium supported by the stage by the drawing head, an exposure device which includes a stage and an exposure head having a spatial light modulation element arranged so as to be relatively movable and exposes a recording medium supported by the stage by the exposure head, and a drawing method performed by the drawing device.

### TECHNICAL BACKGROUND

There has been known an exposure device which passes light modulated by a spatial light modulation element through an imaging optical system and forms an image of the light on a photosensitive material so as to expose the photosensitive material. Such exposure device includes a spatial light modulation element which has a large number of pixel portions modulating each illumination light according to a control signal arrayed in two-dimensional way, a light source which illuminates the spatial light modulation element with light, and an imaging optical system which forms an image of the light modulated by the spatial light modulation element on a photosensitive material, and is widely used for recording a predetermined pattern on a printed wiring board or the substrate of a flat panel display.

In such exposure device, an LCD (liquid crystal device) and a DMD (digital micro-mirror device) are used as the spatial light modulation element. The DMD is a mirror device which has a large number of rectangular micro-mirrors changing the angle of a reflection plane according to a control signal arrayed in two-dimensional way on a semiconductor substrate such as silicon.

When such exposure device is used to expose a predetermined wiring pattern on a substrate, the desired wiring pattern need to be exposed in a desired position on the substrate. High accuracy alignment is necessary.

The position of the DMD relative to the exposure surface may be temporarily shifted due to the influence of disturbance, such as vibration, transmitted from a mounting environment to the exposure device. Thereby, density nonuniformity and exposure position shift may occur, resulting in deterioration of the quality of an exposure image.

To address this problem, there has been proposed a method of mounting the exposure head provided with the DMD and the stage with the substrate placed thereon on an active or passive vibration removing device (see Japanese Patent Application Laid-Open (JP-A) No. 11-327657).

### DISCLOSURE OF THE INVENTION

### Subject to be Addressed by the Invention

In the above related art method, when the size and weight of the exposure device are increased, the cost of the vibration removing device becomes very expensive.

The present invention has been made to address the above problem and an object of the present invention is to provide a drawing device, an exposure device, and a drawing method capable of preventing deterioration of image quality due to abnormal occurrence such as vibration without increasing the cost.

### Means for Addressing the Subjects

To achieve the above object, a drawing device in a first aspect of the invention includes: a drawing component which includes a stage and a drawing head arranged so as to be relatively movable and performs drawing on a recording medium supported by the stage by the drawing head; a moving component that relatively moves the stage and the drawing head; a position detection component that detects the relative position of the stage and the drawing head; an error detection component that detects an abnormal state when an abnormal drawing is performed on the recording medium; and a controller, when the abnormal state is detected, that controls the moving component so as to stop drawing by the drawing head and return the relative position of the stage and the drawing head from the stop position in which drawing by the drawing head is stopped to the position of the drawing start side and controlling the drawing component so as to resume drawing from the position in a predetermined range including the stop position.

In the case that an abnormal state when an abnormal drawing is performed on the recording medium is detected, the controller stops drawing by the drawing head and returns the relative position of the stage and the drawing head from the stop position in which drawing by the drawing head is stopped to the position of the drawing start side, so that drawing may be resumed from the position in a predetermined range including the stop position. Deterioration of image quality due to continued drawing in the abnormal state may be prevented. In addition, deterioration of image quality may be prevented without any special device such as the vibration removing device. The cost may be reduced.

Here, the abnormal state may be at least one of a state that the relative position detected by the position detection component is a first predetermined value or more, a state that the rate of change of the relative position detected by the position detection component is a second predetermined value or more, a state that an acceleration acting on the drawing component is a third predetermined value or more, and a state that an error is caused in image data for drawing.

Thus, the abnormal state such as relative position shift of the stage and the drawing head due to vibration and transmission error of image data may be detected.

The controller may control the moving component so as to return the relative position of the stage and the drawing head from the stop position to the position of the drawing start side and may control the drawing component so as to resume drawing from the position in a predetermined range including the stop position and perform drawing for continuation from an image drawn on the recording medium.

By such control, a high quality image may be drawn without bringing a drawing image before drawing is stopped and a drawing image after drawing is resumed into discontinuous state near the drawing stop position.

The drawing head may be an exposure head having a spatial light modulation element or a droplet discharge head for discharging a droplet.

An exposure device in a second aspect of the present invention includes: an exposure component which includes a stage and an exposure head having a spatial light modulation element arranged so as to be relatively movable and exposing a recording medium supported by the stage by the exposure head; a moving component that relatively moves the stage and the exposure head; a position detection component that detects the relative position of the stage and the exposure head; an error detection component that detects an abnormal state when an abnormal exposure is performed on the recording medium; and a controllers when the abnormal state is detected, that controls the moving component so as to stop exposure by the exposure head and return the relative position of the stage and the exposure head from the stop position in which exposure by the exposure head is stopped to the position of the exposure start side and controls the exposure component so as to resume exposure from the position in a predetermined range including the stop position.

In the case that an abnormal state when an abnormal drawing is performed on the recording medium is detected, the controller stops exposure by the exposure head and returns the relative position of the stage and the exposure head from the stop position in which exposure by the exposure head is stopped to the position of the exposure start side, so that exposure may be resumed from the position in a predetermined range including the stop position. Deterioration of image quality due to continued exposure in the abnormal state may be prevented. In addition, deterioration of image quality may be prevented without any special device such as the vibration removing device. Accordingly, the cost may be reduced.

Here, the abnormal state may be at least one of a state that the relative position detected by the position detection component is a first predetermined value or more, a state that the rate of change of the relative position detected by the position detection component is a second predetermined value or more, a state that an acceleration acting on the exposure component is a third predetermined value or more, and a state that an error is caused in image data for exposure.

Thus, the abnormal state such as relative position shift of the stage and the exposure head due to vibration and transmission error of image data may be detected.

The controller may control the moving component so as to return the relative position of the stage and the drawing head from the stop position to the position of the exposure start side and may control the exposure component so as to resume exposure from the position in a predetermined range including the stop position and perform exposure for continuation from an image exposed on the recording medium.

By such control, a high quality image may be made by exposure without bringing an exposure image before exposure is stopped and an exposure image after exposure is resumed into discontinuous state near the exposure stop position.

A drawing method in a third aspect of the present invention which performs drawing on a recording medium supported by a stage by a drawing head, includes: relatively moving the stage and the drawing head; detecting the relative position of the stage and the drawing head; detecting an abnormal state when an abnormal drawing is performed on the recording medium; and when the abnormal state is detected, performing control so as to stop drawing by the drawing head and return the relative position of the stage and the drawing head from the stop position in which drawing by the drawing head is stopped to the position of the drawing start side and performing control so as to resume drawing from the position in a predetermined range including the stop position.

The drawing method of the present invention functions as the drawing device of the present invention and can prevent deterioration of image quality due to abnormal occurrence such as vibration without increasing the cost.

### EFFECTS OF THE INVENTION

As described above, the drawing device, the exposure device, and the drawing method of the present invention have an excellent advantage of preventing deterioration of image quality due to abnormal occurrence such as vibration without increasing the cost.

### BRIEF EXPLANATION OF THE DRAWINGS

FIG. 1 is a perspective view showing the appearance of an exposure device according to an exemplary embodiment of the present invention.

FIG. 2 is a perspective view snowing the configuration of a scanner of the exposure device.

FIG. 3A is a plan view showing exposed areas formed on a photosensitive material.

FIG. 3B is a diagram showing the arrangement of exposure areas of exposure heads.

FIG. 4 is a perspective view showing the schematic configuration of the exposure head of the exposure device.

FIG. 5 is a partially enlarged view showing the structure of a digital micro-mirror device (DMD).

FIG. 6A is an explanatory view for explaining the operation of the DMD.

FIG. 6B is an explanatory view for explaining the operation of the DMD.

FIG. 7A is a plan view showing comparison of the arrangement of exposure beams and scan lines when the DMD is not tilted and tilted.

FIG. 7B is a plan view showing comparison of the arrangement of exposure beams and scan lines when the DMD is not tilted and tilted.

FIG. 8A is a perspective view showing the configuration of a fiber array light source.

FIG. 8B is a front view showing the arrangement of light emission points of a laser emission unit of the fiber array light source.

FIG. 9 is a block diagram showing the electric configuration of the exposure device.

FIG. 10 is a perspective view showing the configuration of a position measurement unit.

FIG. 11 is a flowchart showing the processing routine of exposure control executed by a control unit.

FIG. 12 is a diagram showing split exposure image data.

FIG. 13A is an explanatory view for providing a parallel plate to the exposure head so as to control the direction of a laser beam by rotation of the parallel plate.

FIG. 13B is an explanatory view for providing a parallel plate to the exposure head so as to control the direction of a laser beam by rotation of the parallel plate.

FIG. 14 is a diagram schematically showing a specific example of exposure control in an X direction.

FIG. 15 is a diagram schematically showing a specific example of exposure control in a Y direction.

### BEST MODE FOR IMPLEMENTING THE INVENTION

An exposure device according to an exemplary embodiment of the present invention will be described below with reference to the drawings.

### (The Configuration of the Exposure Device)

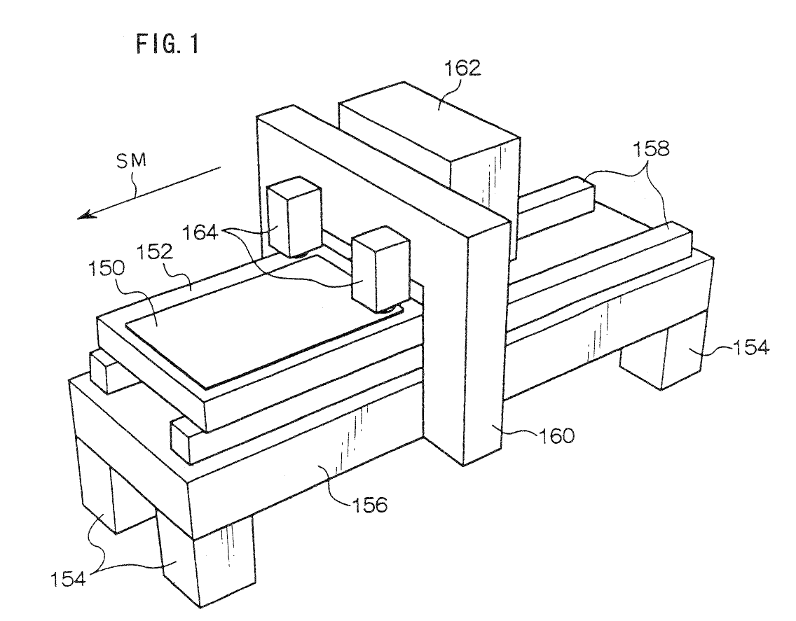

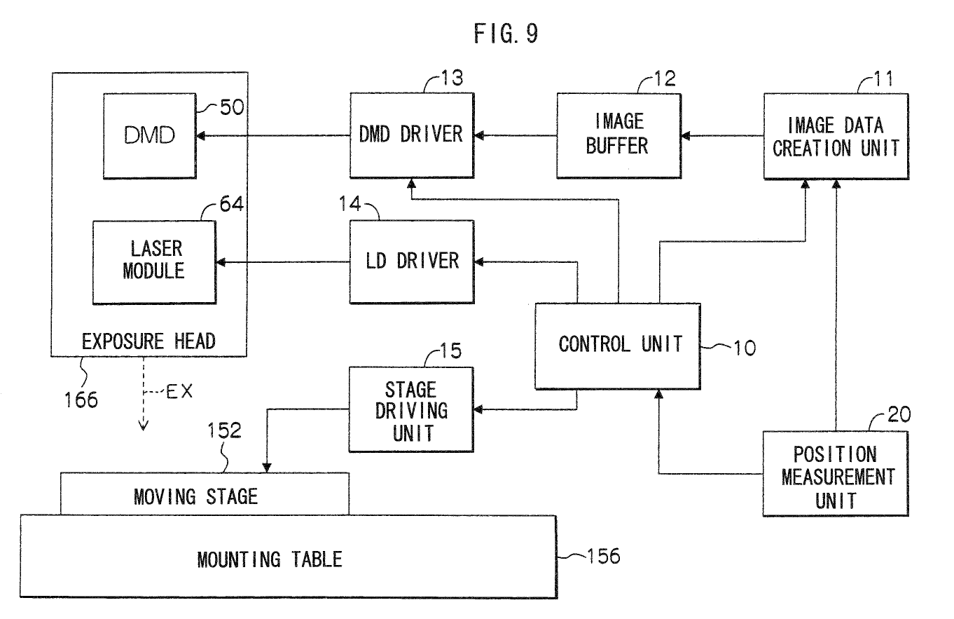

As shown in FIG. 1, the exposure device includes a planar moving stage 152 for absorbing a sheet-like photosensitive material 150 onto its surface and holding it. Two guides 158 extended in a stage moving direction (arrow SM) are provided on the upper surface of a thick plate-like mounting table 156 supported by four legs 154. The moving stage 152 is arranged in such a manner that its longitudinal direction is directed in the stage moving direction and is reciprocatively supported by the guides 158. The exposure device has a later-described stage driving unit 15 (see FIG. 9) for driving the moving stage 152 as a sub-scan component along the guides 158.

The mounting table 156 has in its middle portion a U-shaped gate 160 so as to straddle the moving path of the moving stage 152. The respective ends of the U-shaped gate 160 are fixed to both side surfaces of the mounting table 156. The gate 160 is interposed between a scanner 162 provided on one side of the gate 160 and a plurality (e.g., two) of sensors 164 for detecting the front edge and the rear edge of the photosensitive material 150 provided on the other side thereof. The scanner 162 and the sensors 164 are mounted on the gate 160 and fixed above the moving path of the moving stage 152. The scanner 162 and the sensors 164 are connected to a control unit for controlling these.

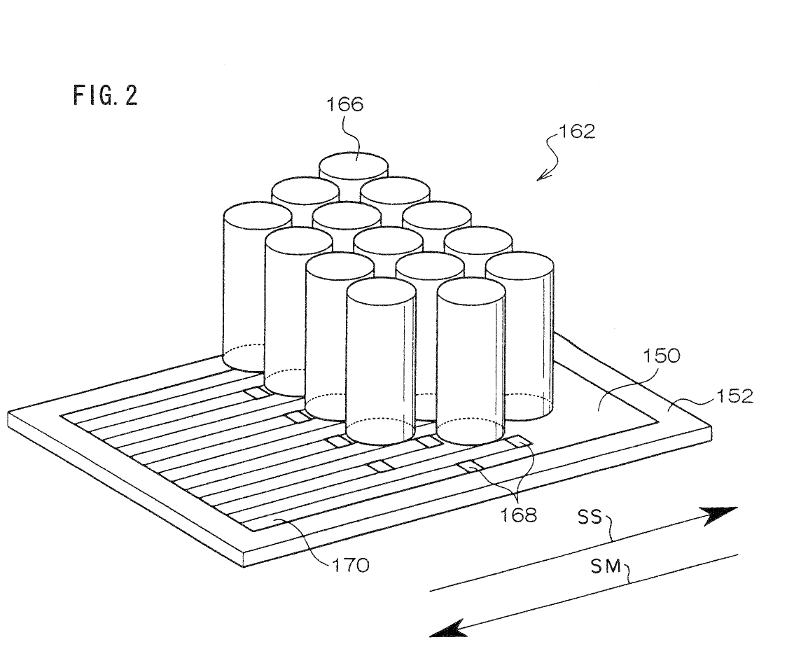

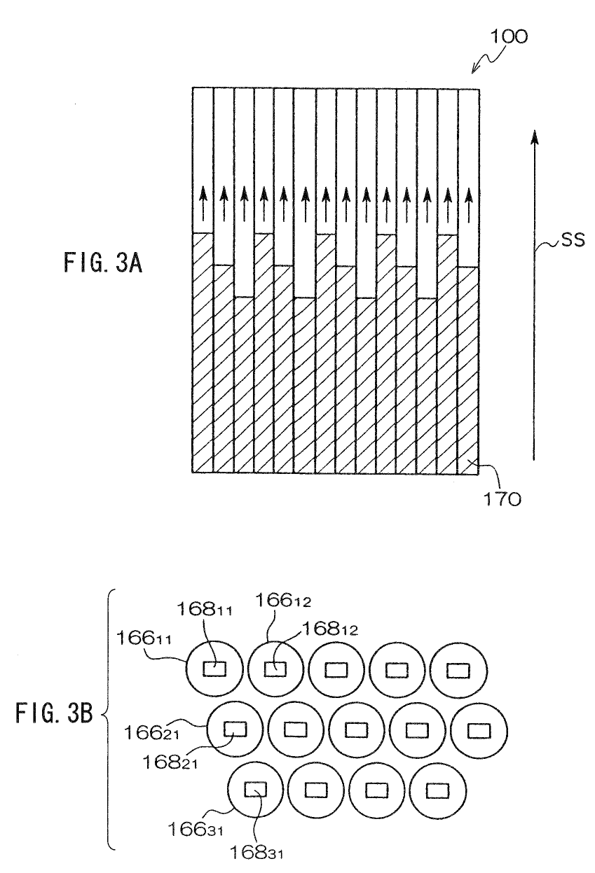

As shown in FIGS. 2 and 3B, the scanner 162 has a plurality (e.g., 14) of exposure heads 166 arrayed in a substantially matrix of m rows and n columns (e.g., three rows and five columns) (an arrow EX indicates exposure). In this example, due to the width of the photosensitive material 150, the four exposure heads 166 are arranged in the third row. Each of the exposure heads arrayed in the mth row and the nth column is represented as the exposure head 166ₘₙ.

An exposure area 168 of the exposure head 166 is in a rectangular shape having a short side in a sub-scan direction (an arrow SS). A band-shaped exposed area 170 is formed on the photosensitive material 150 for each of the exposure heads 166 with movement of the moving stage 152. The exposure area of each of the exposure heads arrayed in the mth row and the nth column is represented as the exposure area 168ₘₙ.

As shown in FIGS. 3A and 3B, each of the exposure heads 166 in each row arrayed in a line is arranged so as to be shifted at a predetermined interval (natural number times, twice in this example, the long side of the exposure area) in an array direction (one constant low speed scanning in the sub-scan direction may be, e.g., 40 mm/s) in such a manner that the band-shaped exposed area 170 is arranged without space in a direction orthogonally intersecting the sub-scan direction. The unexposed portion between the exposure area 168₁₁ and the exposure area 168₁₂ in the first row may be exposed by the exposure area 168₂₁ in the second row and the exposure area 168₃₁ in the third row.

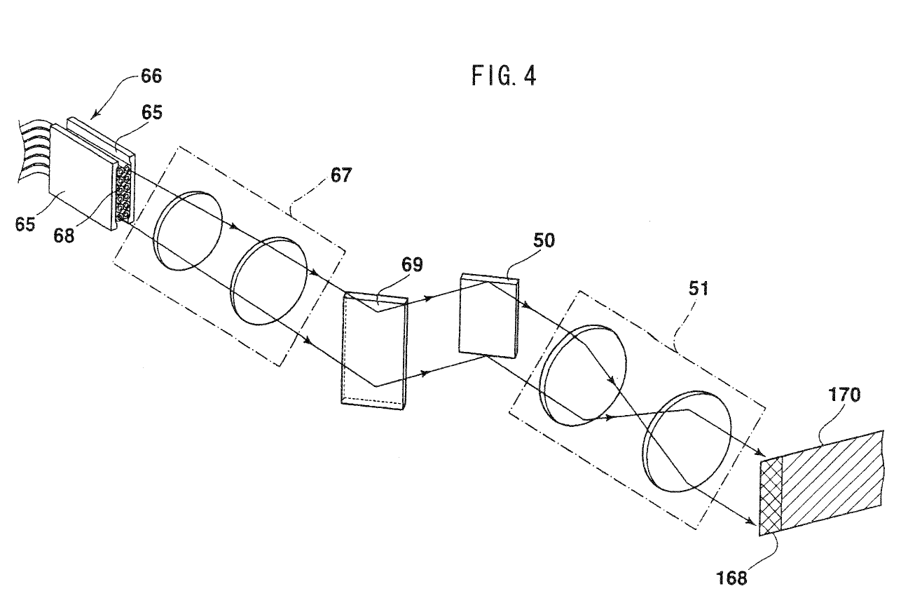

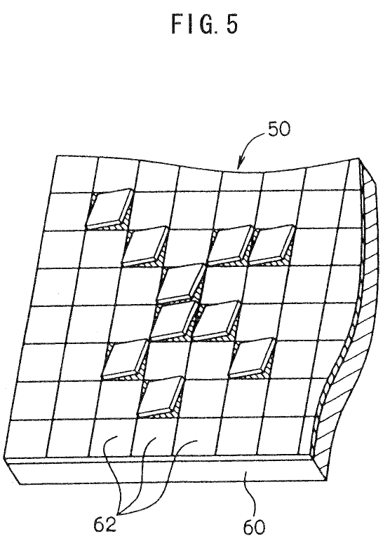

As shown in FIGS. 4 and 5, each of the exposure heads 166₁₁ to 166ₘₙ has a digital micro-mirror device (DMD) 50 manufactured by Texas Instruments Inc. in the United States as a spatial light modulation element for modulating an incident optical beam for each pixel according to image data. The DMD 50 is connected to a later-described DMD driver 13 (see FIG. 9) having a data processing unit and a mirror drive control unit. The data processing unit of the DMD driver 13 generates a control signal for drive-controlling each micro-mirror in an area to be controlled in the DMD 50 for each of the exposure heads 166 according to inputted image data. The mirror drive controlling unit controls the angle of the reflection plane of each of the micro-mirrors in the DMD 50 for each of the exposure heads 166 according to the control signal generated by the image data processing unit. Control of the angle of the reflection plane will be described later.

A fiber array light source 66 having a laser emission unit having emission ends (light emission points) of optical fibers arranged in a line in the direction corresponding to the long side direction of the exposure area 168, a lens system 67 for correcting a laser beam emitted from the fiber array light source 66 and focusing it on the DMD, and a mirror 69 for reflecting the laser beam passed through the lens system 67 toward the DMD 50 are arranged on the light incidence side of the DMD 50 in that order. The lens system 67 has a focusing lens for focusing the laser beam as illumination light emitted from the fiber array light source 66, a rod-like optical integrator (hereinafter, called a rod integrator) inserted in the optical path of the beam passed through the focusing lens, and an imaging lens arranged on the mirror 69 side forwardly of the rod integrator. The focusing lens, rod integrator, and imaging lens allow the laser beam emitted from the fiber array light source 66 as a light flux which is substantially a parallel beam and has a uniform intensity in beam section to be incident on the DMD 50.

The laser beam emitted from the lens system 67 is reflected on the mirror 69 so as to illuminate the DMD 50 via a TIR (total internal reflection) prism.

An imaging optical system 51 for forming an image of the laser beam reflected on the DMD 50 on the photosensitive material 150 is arranged on the light reflection side of the DMD 50. The imaging optical system 51 has a plurality of imaging lenses for magnifying and projecting an image and inserts a micro-lens array having a large number of micro-lenses corresponding to the pixels of the DMD 50 arrayed in two-dimensional way between the plurality of imaging lenses.

As shown in FIG. 5, the DMD 50 is a mirror device having a large number (e.g., 1024×768) of micro-mirrors 62 structuring pixels arrayed in grating on an SRAM cell (memory cell) 60. Each of the pixels has, in its topmost portion, the rectangular micro-mirror 62 supported by a support. A material having a high reflectivity, such as aluminum, is deposited on the surface of the micro-mirror 62. The reflectivity of the micro-mirror 62 is 90% or more. Its array pitch is 13.7 μm as an example in both the vertical direction and the horizontal direction. The SCAM cell 60 of a CMOS of a silicon gate manufactured on a typical semiconductor memory manufacturing line is arranged just below the micro-mirror 62 via the support including a hinge and yoke. The entire SRAM 60 is configured so as to be monolithic.

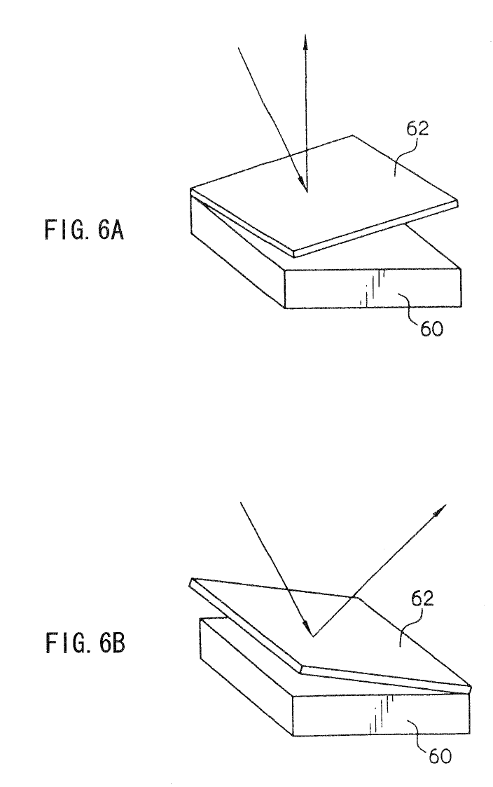

When a digital signal is written onto the SRAM cell 60 of the DMD 50, the micro-mirror 62 supported by the support is tilted in the range of ±α° (e.g., ±12°) with respect to the substrate side arranging the DMD 50 on a diagonal line. FIG. 6A shows the state that the micro-mirror 62 is tilted at the +α° in which it is in on state. FIG. 6B shows the state that the micro-mirror 62 is tilted at the −α° in which it is in off state. The tilt of the micro-mirror 62 of each of the pixels of the DMD 50 is controlled according to an image signal, as shown in FIG. 5. The laser beam incident on the DMD 50 is reflected in the tilt direction of each of the micro-mirrors 62.

FIG. 5, in which part of the DMD 50 is enlarged, shows an example of the state that the micro-mirror 62 is controlled to the +α° or −α°. The on-off control of each of the micro-mirrors 62 is performed by the DMD driver 13 connected to the DMD 50. An optical absorber is arranged in the traveling direction of the laser beam reflected on the micro-mirror 62 in off state.

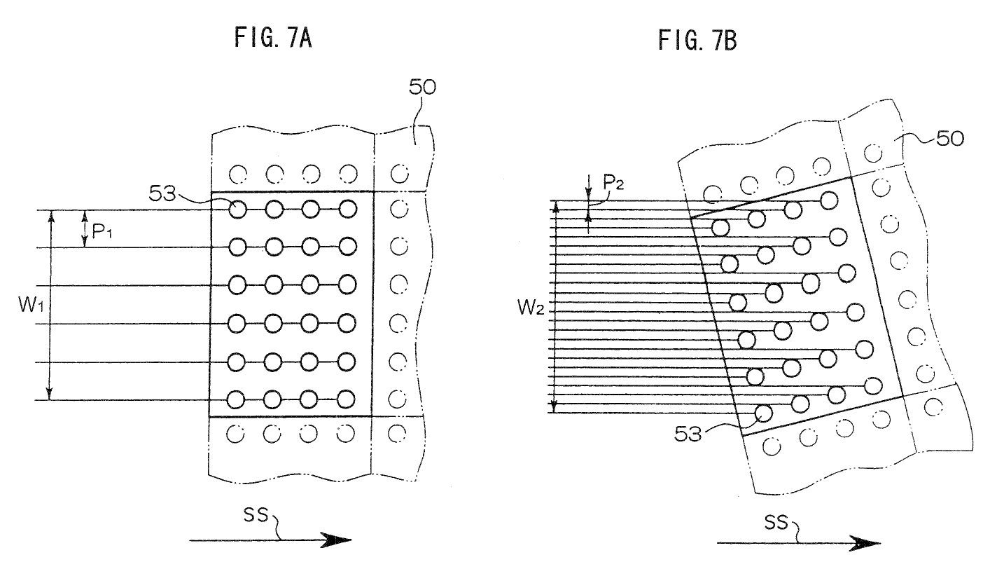

Preferably, the DMD 50 is arranged so as to be slightly tilted in such a manner that its short side forms a predetermined angle (e.g., 0.1° to 5°) with the sub-scan direction. FIG. 7A shows the scan trajectories of reflection light images (exposure beams) 53 of the micro-mirrors when the DMD 50 is not tilted. FIG. 7B shows the scan trajectories of the exposure beams 53 when the DMD 50 is tilted.

A large number of sets (e.g., 756 sets) of micro-mirror lines having a large number (e.g., 1024) of micro-mirrors 62 arrayed in a longitudinal direction are arrayed in the DMD 50 in a lateral direction. As shown in FIG. 7B, the DMD 50 is tilted so that a pitch P₁ between the scan trajectories (scan lines) of the exposure beams 53 by the micro-mirrors 62 is smaller than a pitch P₂ between the scan lines when the DMD 50 is not tilted. This can greatly improve a resolution. The angle of tilt of the DMD 50 is very small. A scan width W₂ when the DMD 50 is tilted is substantially equal to a scan width W₁ when the DMD 50 is not tilted.

Overlap-exposure (multi-exposure) is performed on the same scan line by different micro-mirror lines. By such multi-exposure, a small amount of the exposure position may be controlled for realizing high-resolution exposure. The plurality of exposure heads arrayed in a main scan direction can be joined without a step by control of a very small amount of the exposure position.

In place of tilting the DMD 50, each of the micro-mirror lines is staggered so as to be shifted at a predetermined interval in the direction orthogonally intersecting the sub-scan direction. The same advantage can be obtained.

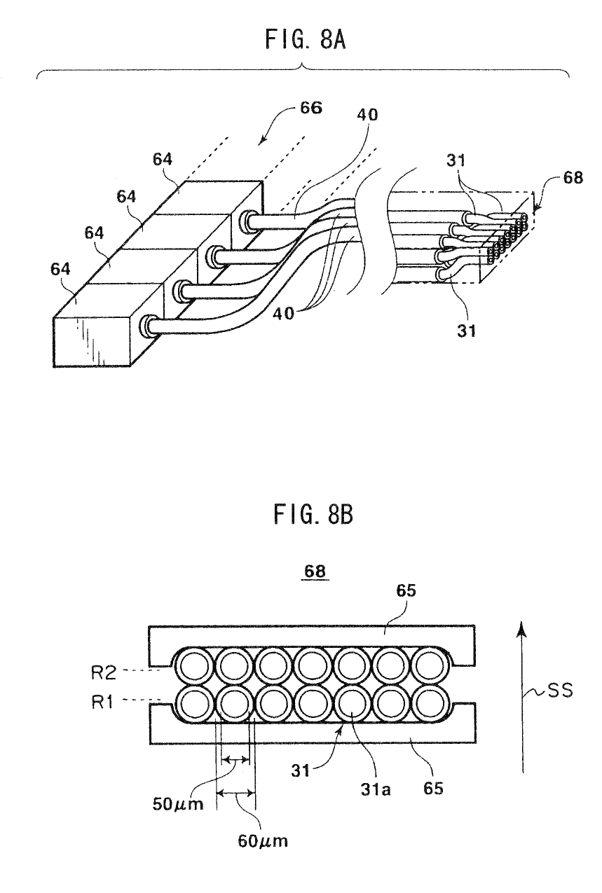

As shown in FIG. 8A, the fiber array light source 66 has a plurality (e.g., 14) of laser modules 64. Each of the laser modules 64 is connected to one end of a multimode optical fiber 40. The other end of the multimode optical fiber 40 is connected to an optical fiber 31 having the same core diameter as that of the multimode optical fiber 40 and a clad diameter smaller than that of the multimode optical fiber 40. As shown in FIG. 8B in detail, seven ends of the optical fibers 31 on the opposite sides of the multimode optical fibers 40 are arranged in the main scan direction orthogonally intersecting the sub-scan direction and are arranged in two rows (R1: the first row and R2: the second row) so as to configure a laser emission unit 68.

As shown in FIG. 8B, the laser emission unit 68 configured by the ends of the optical fibers 31 is interposed and fixed between two support plates 65 whose surface is flat. It is preferred that a transparent protective plate such as glass be arranged on the light emission end face of the optical fiber 31 for protecting the same. The light emission end face of the optical fiber 31 has a high light density; it easily collects dust and, accordingly, is easily deteriorated. Arrangement of the above protective plate can prevent dust from being attached to the end face and, accordingly, can delay deterioration.

The laser module 64 has a multiplexing laser light source (fiber light source). The multiplexing laser light source has GaN semiconductor lasers in transverse-multimode like plural chips arrayed and fixed on a heat block or a GaN semiconductor laser in single mode, a collimator lens provided corresponding to each of the GaN semiconductor lasers, one focusing lens, and one multimode optical fiber 40. In place of the plurality of collimator lenses, a collimator lens array having the lenses integrated may be used.

The electric configuration of the exposure device in this example will be described with reference to FIG. 9. As shown in FIG. 9, a control unit 10 for controlling the entire exposure device is connected to an image data creation unit 11 for creating binary image data for exposure (exposure image data) according to input image data, an image buffer 12 for temporarily storing the image data created by the image data creation unit 11, the DMD driver 13 for controlling drive of the DMD 50 according to the image data of the image buffer 12, an LD driver 14 for controlling drive of the laser module 64, the stage driving unit 15 for controlling movement of the moving stage 152, and a position measurement unit 20 for measuring the position of the moving stage 152.

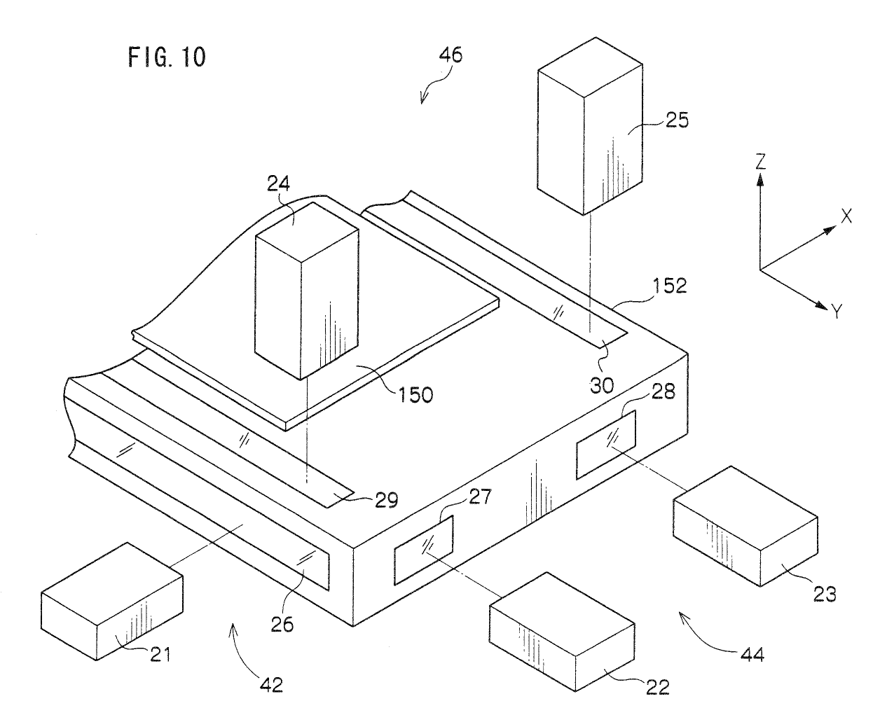

The position measurement unit 20 is provided for determining the position of the moving stage 152 and the amount of displacement (the amount of relative position shift of the exposure head 166 and the moving stage 152). As shown in FIG. 10, the position measurement unit 20 has an X direction position measurement unit 42 for measuring the position of the moving stage 152 in an X direction, a Y direction position measurement unit 44 for measuring the position of the moving stage 152 in a Y direction, and a Z direction position measurement unit 46 for measuring the position of the moving stage 152 in a Z direction.

The X direction position measurement unit 42 has a side surface mirror 26 provided on the side surface of the moving stage 152 extended in its moving direction, and an X direction laser length measurement unit 21 for emitting a laser beam to the side surface mirror 26 and detecting its reflection light so as to measure the distance to the side surface mirror 26.

The Y direction position measurement unit 44 has cube mirrors 27 and 28 provided on the side surface of the moving stage 152 extended in the direction orthogonally intersecting its moving direction, a first Y direction laser length measurement unit 22 for emitting a laser beam to the cube mirror 27 and detecting its reflection light so as to measure the distance to the cube mirror 27, and a second Y direction laser length measurement unit 23 for emitting a laser beam to the cube mirror 28 and detecting its reflection light so as to measure the distance to the cube mirror 28.

The Z direction position measurement unit 46 has upper surface mirrors 29 and 30 provided on the portions in which the photosensitive material 150 is not absorbed onto the surface of the moving stage 152 opposite the exposure head 166, a first Z direction laser length measurement unit 24 for emitting a laser beam to the upper surface mirror 29 and detecting its reflection light so as to measure the distance to the upper surface mirror 29, and a second Z direction laser length measurement unit 25 for emitting a laser beam to the upper surface mirror 30 and detecting its reflection light so as to measure the distance to the upper surface mirror 30.

In FIG. 10, only one X direction laser length measurement unit 21 is provided. Actually, a sufficient number of X direction laser length measurement units 21 are provided for determining the amount of displacement of the moving stage 152 in the X direction during exposure.

Only one X direction laser length measurement unit 21 may be provided and the length of the side surface mirror 26 may be a sufficient length for determining the amount of displacement during exposure.

The upper surface mirrors 29 and 30 for measuring the position in the Z direction may have a sufficient length for determining the amount of displacement during exposure.

The stage driving unit 15 moves the moving stage 152 in the Y direction. The exposure device has a linear encoder for outputting a pulse signal with movement of the moving stage 152 and detects the position information and scan speed of the moving stage 152 according to the pulse signal from the linear encoder. The stage driving unit 15 may move the moving stage 152 at a fixed speed according to the pulse signal from the linear encoder. The position measurement unit 20 performs position measurement for each predetermined number of pulses and outputs a measured result (position information) to the control unit 10.

The control unit 10 outputs a control signal for performing exposure according to image data to the DMD driver 13 and the LD driver 14 according to reset timing during exposure. Here, the reset timing is timing for rewriting data of the DMD 50 and switching the state of the micro-mirror 62 of the DMD 50. The reset timing is typically set to timing at an interval of the predetermined number of pulses of the linear encoder. When the moving stage 152 is shifted due to vibration, it is adjusted according to position shift, as needed (the detail will be described later). Position shift of the moving stage 152 is judged from the position information measured by the position measurement unit 20.

### (The Operation of the Exposure Device)

The exposure operation of the exposure device will be described below.

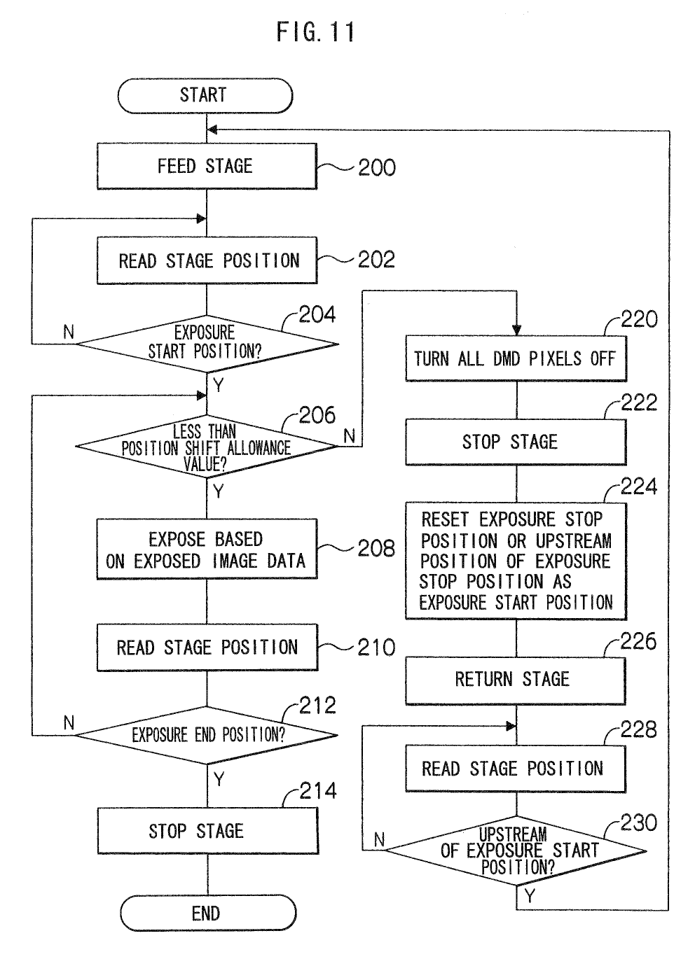

FIG. 11 is a flowchart showing the processing routine of exposure control executed by the control unit 10. By way of example, the control shown in FIG. 11 is executed when the exposure device is turned on.

In step 200, the moving stage 152 with the photosensitive material 150 absorbed onto its surface is moved at a fixed speed from upstream to downstream along the guides 158 by the stage driving unit 15.

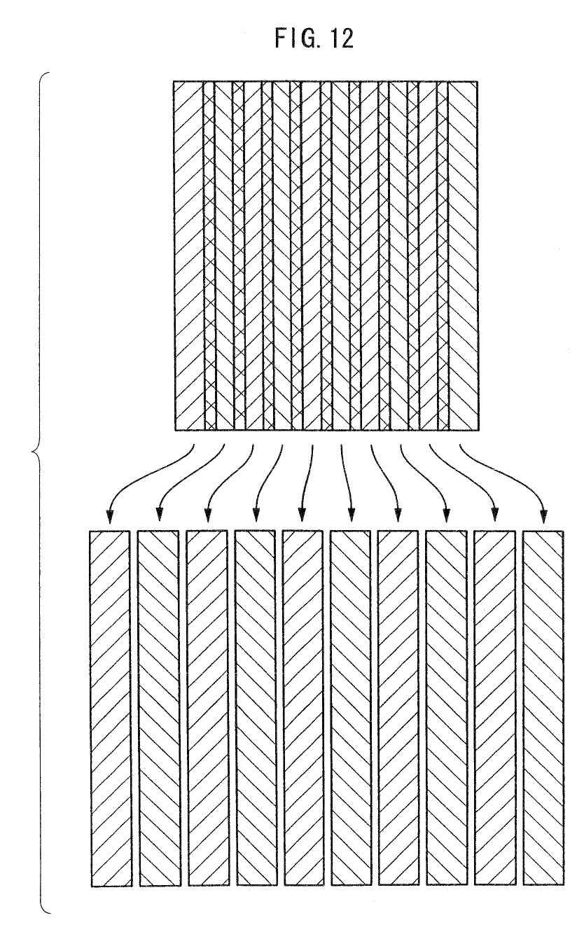

While the moving stage 152 is moved, the image data creation unit 11 creates image data according to an exposure pattern (exposure image data), and as shown in FIG. 12, and splits it into split exposure image data for each of the exposure heads 166 so as to store the split data in the image buffer 12. The exposure image data (split exposure image data) is data representing the density of each pixel structuring an image in binary (the presence or absence of dot recording).

In step 202, the position measurement unit 20 reads position information of the moving stage 152 in the X, Y, and Z directions.

In detail, a laser beam is emitted from the X direction laser length measurement unit 21 to the side surface mirror 26, laser beams are emitted from the first Y direction laser length measurement unit 22 and the second Y direction laser length measurement unit 23 to the cube mirrors 27 and 28, and laser beams are emitted from the first Z direction laser length measurement unit 24 and the second Z direction laser length measurement unit 25 to the upper surface mirrors 29 and 30.

The laser beam emitted from the X direction laser length measurement unit 21 is reflected on the side surface mirror 26, and its reflection light is detected by the X direction laser length measurement unit 21 so as to measure the distance to the side surface mirror 26. The laser beams emitted from the first Y direction laser length measurement unit 22 and the second Y direction laser length measurement unit 23 are reflected on the cube mirrors 27 and 28 and their reflection lights are detected by the first Y direction laser length measurement unit 22 and the second Y direction laser length measurement unit 23 so as to measure the distances to the cube mirrors 27 and 28. The laser beams emitted from the first Z direction laser length measurement unit 24 and the second Z direction laser length measurement unit 25 are reflected on the upper surface mirrors 29 and 30 and their reflection lights are detected by the first Z direction laser length measurement unit 24 and the second Z direction laser length measurement unit 25 so as to measure the distances to the upper surface mirrors 29 and 30.

Position information X1 of the moving stage 152 in the X direction is determined according to the measured result of the X direction position measurement unit 42. Position information Y1 and position information Y2 of the moving stage 152 in the Y direction are determined according to the measured results of the Y direction position measurement unit 44. Position information Z1 and position information Z2 of the moving stage 152 in the Z direction are determined according to the measured results of the Z direction position measurement unit 46.

In step 204, it is judged whether or not the moving stage 152 is moved to the exposure start position. Here, the exposure start position is a position for actually starting exposure on the photosensitive material 150 by the exposure head 166 and is previously set. A predetermined initial value as the exposure start position is set immediately after exposure is started and is reset when abnormality such as position shift occurs (this will be described later). In step 204, the detected position information Y1 or position information Y2 is compared with information on the predetermined exposure start position in the Y direction. When they are substantially matched with each other, the current position of the moving stage 152 is judged to be the exposure start position.

In step 204, it is judged that the moving stage 152 is not moved to the exposure start position. The routine is returned to step 202 and the processes in steps 202 and 204 are repeated until the moving stage 152 is moved to the exposure start position.

In step 204, it is judged that the moving stage 152 is moved to the exposure start position. The routine is moved to step 206 so as to judge whether or not the amount of relative position shift (the amount of displacement) of the moving stage 152 and the exposure head 166 is less than an allowance value. The process in step 206 will be described here in detail.

It is judged whether or not the difference between the position information X1, Y1, Y2, Z1, or Z2 obtained from the position measurement unit 20 and position information as reference when the moving stage 152 is ideally moved (reference position information) X0, Y0, or Z0 is less than a predetermined allowance value Xth, Yth, or Zth. The allowance values Xth, Yth, and Zth may be different in the X, Y, and Z directions or may be the same. The difference between Y1 and Y2 is determined as the amount of rotation θ1 on an X-Y plane so as to judge whether or not the amount of rotation θ1 is less than a predetermined allowance value θ1th. The difference between Z1 and Z2 is determined as the amount of rotation θ2 on an X-Z plane so as to judge whether or not the amount of rotation θ2 is less than a predetermined allowance value θ2th. The allowance values θ1th and θ2th may be different or may be the same.

When at least one of the difference between the position information X1, Y1, Y2, Z1, or Z2 and the reference position information X0, Y0, or Z0 and the amount of rotation θ1 and θ2 is the allowance value or more, the judgment in step 206 is negative so as to judge that the moving stage 152 is shifted due to vibration.

When the difference between the position information X1, Y1, Y2, Z1, or Z2 and the reference position information X0, Y0, or Z0 and the amount of rotation θ1 and θ2 are less than the allowance value, the judgment in step 206 is affirmative so as to judge that position shift due to vibration does not occur.

When the judgment in step 206 is affirmative, the photosensitive material 150 is exposed according to the exposure image data in step 208. In detail, the data processing unit of the DMD driver 13 reads the split exposure image data stored in the image buffer 12 and generates a control signal according to the corresponding split exposure image data for each of the exposure heads 166. The mirror drive controlling unit of the DMD driver 13 on-off controls each of the micro-mirrors of the DMD 50 for each of the exposure heads 166 according to the generated control signal.

In each of the exposure heads 166 of the scanner 162, the laser module 64 is driven by the LD driver 14 so as to emit a laser beam from the fiber array light source 66.

When the laser beam is emitted from the fiber array light source 66 to the DMD 50, the laser beam reflected on the micro-mirror of the DMD 50 in on state is imaged on the photosensitive material 150 by the imaging optical system 51. The laser beam emitted from the fiber array light source 66 is turned on/off for each pixel. The photosensitive material 150 is exposed in pixels (exposure areas 168) which are substantially equal in number to that of pixels used in the DMD 50. The photosensitive material 150 is moved at a fixed speed together with the moving stage 152. The band-shaped exposed area 170 is formed for each of the exposure heads 166 (see FIG. 2).

A control signal according to predetermined reset timing is outputted from the control unit 10 to the DMD driver 13. The DMD driver 13 is operated according to the control signal so as to perform the on-off switching operation of the DMD 50 according to the reset timing.

The moving stage 152 is moved by the stage driving unit 15 from upstream to downstream at a fixed speed. In step 210, as in step 202, the position measurement unit 20 reads position information of the moving stage 152 in the X, Y, and Z directions.

In step 212, it is judged whether or not the moving stage 152 is moved to the exposure end position. The exposure end position is a position in the Y direction for ending exposure by the exposure head 166 and is previously set.

In step 212, when it is judged that the moving stage 152 is not moved to the exposure end position, the routine is returned to step 206.

When the judgment is negative (at least one of the difference between the position information X1, Y1, Y2, Z1, or Z2 and the reference position information X0, Y0, or Z0 and the amount of rotation θ1 and θ2 is the allowance value or more) in step 206, the routine is moved to step 220.

In step 220, a control signal is outputted to the DMD driver 13 so as to turn off all pixels of the DMD 50 for stopping exposure. At this time, the control signal may be outputted to the LD driver 14 so as to turn off emission of the laser beam for stopping exposure.

In step 222, the moving stage 152 stops to move at the substantially same time as the exposure is stopped in step 220.

In step 224, the position (exposure stop position) of the moving stage 152 or an upstream position of the exposure stop position by a predetermined amount is reset as a new exposure start position in place of the predetermined position. Here, the predetermined amount may be an amount in a range, in which an exposure image after exposure is resumed may be formed so as to be overlapped on an exposure image exposed before exposure is stopped to the extent that the joint portion is not noticeable and is not unnatural. In this exemplary embodiment, an image is drawn by multi-exposure and an image before exposure is stopped and an image after exposure is stopped may be overlapped on each other in at least part of the joint portion for a predetermined number of multi-drawings. The number of multi-drawings partially in excess of the predetermined number of multi-drawings may be larger than the predetermined number of multi-drawings by one to several multi-drawings (the number of multi-drawings which is less than twice the predetermined number of multi-drawings). Therefore, a high quality image may be obtained in the joint portion. The portion, at which the drawing position of an image after exposure is stopped is different that of an image before exposure is stopped, is drawn by the number of multi-drawings less than the predetermined number of multi-drawings. This may improve the image.

In step 226, the moving stage 152 is moved from downstream to upstream and is returned to at the upstream position of the reset exposure start position. Here, when the moving stage 152 is instructed to be stopped, the moving stage 152 may overrun from the off position (exposure stop position) of the DMD 50 and stop. In this case, the moving stage 152 is returned to the exposure stop position by the amount of overrun. Further, when exposure is resumed from the reset exposure start position, in consideration of requiring long time to the startup of the DMD 50 and the laser module 64, the moving stage 152 is returned to the upstream position of the exposure start position so as to reliably resume exposure from the reset exposure start position.

In step 228, as in step 202, the position measurement unit 20 reads position information of the moving stage 152 in the Y direction. In step 230, it is judged that whether or not the current moving stage 152 is returned to the upstream position of the reset exposure start position by the predetermined amount. In step 230, when the judgment is negative, the routine is returned to step 228 so as to continuously move the moving stage 152 from downstream to upstream. In step 230, when the judgment is affirmative, the routine is returned to step 200 so as to move the moving stage 152 from upstream to downstream at a fixed speed in order to resume exposure.

As described above, in step 202, the position measurement unit 20 reads position information of the moving stage 152 in the X, Y, and Z directions. In step 204, it is judged whether or not the moving stage 152 is moved to the exposure start position. The exposure start position is the exposure start position reset in step 224.

When, in step 204, it is judged that the moving stage 152 is moved to the exposure start position, as described above, the routine is moved to step 206 so as to judge whether or not position shift of the moving stage 152 is less than the allowance value. When the judged in step 206 is negative, the routine is moved to step 220 so as to repeat the above-described process.

When the judgment in step 206 is affirmative, the photosensitive material 150 is exposed according to the exposure image data in step 208. At this time, exposure may be performed as typically. On the other hand, exposure of the exposure head 166 may be controlled in such a manner that the photosensitive material 150 is not exposed so as to discontinue from an exposure image exposed before exposure is stopped, that is, exposure is started so as to continue from an already exposed exposure image. The exposure control will be described below in detail.

When position shift in the X direction is detected, the direction of the laser beam is adjusted using a parallel plate for performing exposure so that the exposure image is continuous in the X direction.

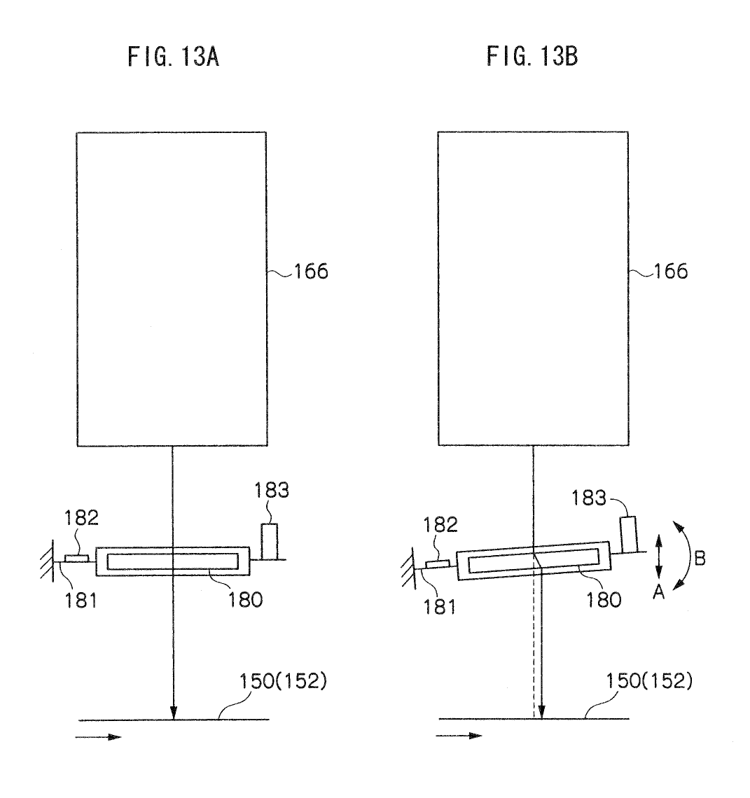

As shown in FIGS. 13A and 13B, a parallel plate 180 formed of glass and the like is provided for each of the exposure heads 166. The parallel plate 180 may be provided as part of the imaging optical system 51. The parallel plate 180 orthogonally intersects the optical axis of the exposure head 166 and is rotatably supported about the axis parallel with the Y direction. A plate spring 181 is provided at one end of the parallel plate 180 in the X direction. One end of the plate spring 181 is fixed to part of the housing of the exposure device. The plate spring 181 has a deformation gage 182. A piezo-actuator 183 is provided at the other end of the parallel plate 180.

The piezo-actuator 183 is extended and contracted in an arrow A direction shown in FIG. 13B according to the input control signal and the output result of the deformation gage 182. Since the piezo-actuator 183 is extended and contracted in the arrow A direction, the parallel plate 180 is rotated in a B direction. The illumination position of a laser beam emitted from the exposure head 166 onto the photosensitive material 150 in the X direction may be moved in the X direction. The angle of rotation of the parallel plate 180 is set according to the amount of displacement in the X direction (the difference between the reference position information X0 and the measured position information X1). The control signal according to setting is input to the piezo-actuator 183 so as to expose an image in a desired position.

A specific example of exposure control will be described below using FIG. 14. Here, the reset exposure start position is the position in which the DMD 50 is turned off (exposure stop position). In FIG. 14, ES denotes the exposure stop position, DS denotes upstream, and US denotes downstream.

FIG. 14 (left) is a diagram showing an exposure state when exposure is started from the exposure stop position (the reset exposure start position) without considering position shift in the X direction in the exposure stop position. As shown in the drawing, an exposure image before exposure is stopped and an exposure image after exposure is resumed are shifted from each other and are discontinuous in the exposure stop position.

FIG. 14 (middle) is a diagram showing an exposure state when the parallel plate 180 is rotated as described above according to the amount of position shift (the amount of displacement) in the X direction so as to change the direction of a laser beam for performing exposure. As shown in the drawing, the exposure image before exposure is stopped and the exposure image after exposure is resumed are not shifted each other and are continuous in the exposure stop position.

Thus, exposure is controlled such that exposure is resumed so as to continue from the already exposed exposure image. Thereby, a more satisfactory exposed result is obtained. As described above, overlap-exposure is performed on the same scan line by different micro-mirror lines in the two-dimensional spatial light modulation element such as the DMD 50. Therefore, even when exposure is stopped once due to vibration and is resumed, position shift of the joint portion is hard to occur. When the request for image quality is not high, exposure may be resumed from the exposure stop position without considering position shift, as shown in FIG. 14 (left).

FIG. 14 (middle) is a diagram showing an exposure state when the state of position shift in the X direction is maintained until exposure is ended or next position shift occurs. As shown in FIG. 14 (right), the position shift state may be gently returned to the original position where position shift does not exist. In this case, the control signal is generated in such a manner that the angle of rotation of the parallel plate 180 is gently returned and is input to the piezo-actuator 183.

Exposure control when position shift in the Y direction is detected will be described. In the Y direction, an image may be continuously exposed by adjusting the reset timing. As described previously, the reset timing is timing at an interval of the predetermined number of pulses of pulse signals output from the linear encoder. Here, the number of pulses set as the reset timing is increased or decreased according to the amount of displacement in the Y direction. This can expose a desired exposure image in a desired position in the Y direction. When exposure is delayed (the reset timing is delayed) in the Y direction, the number of pulses may be increased. When exposure is fastened (the reset timing is fastened), the number of pulses may be decreased.

When the posture of the moving stage 152 is tilted due to vibration (the amount of rotation θ1 exceeds the allowance value) so that an exposure image is tilted, it is necessary to resume exposure with intentional tilt so as to continue from the tilted exposure image. As described above, the number of pulses is increased or decreased so as to shift the reset timing for each of the exposure heads 166 for performing exposure.

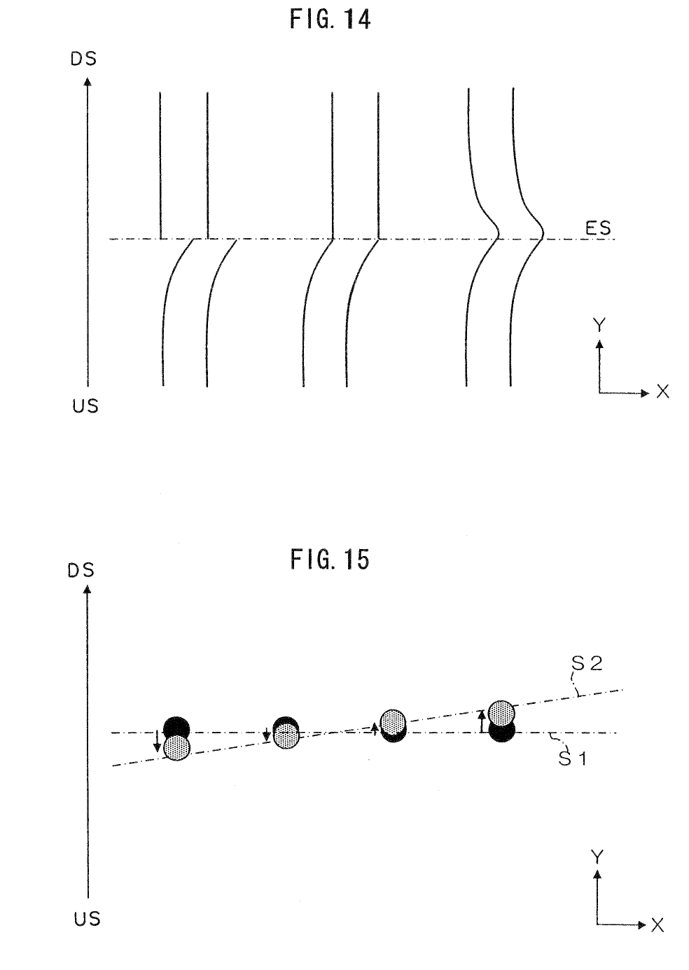

When tilting as indicated by an alternate long and short dash line S2 of FIG. 15 occurs and exposure is resumed without considering position shift in the exposure stop position, exposure is started without tilting as indicated by an alternate long and short dash line S1 of FIG. 15. The exposure image before exposure is stopped and the exposure image after exposure is resumed are discontinuously formed. The reset timing of each of the exposure heads 166 is shifted so as to form an exposure image from the position indicated by the alternate long and short dash line S2 of FIG. 15. The exposure image after exposure is resumed may be formed so as to continue from the exposure image before exposure is stopped.

When the reset timing is changed when exposure is resumed, it is preferable to perform control in such a manner that the changed reset timing is gently returned to the original reset timing.

Exposure control when position shift in the Z direction is detected will be described. When position shift occurs in the Z direction, an exposure position is not shifted and an imaging position is shifted. Thereby, the beam diameter of a laser beam on the photosensitive material 150 is changed. Therefore, exposure may be stopped once so as to emit the laser beam as typically when exposure is resumed or the beam diameters of the exposure image before exposure is stopped and the exposure image after exposure is resumed may be controlled so as to be equal to each other near the exposure stop position. For example, a lens configuring the imaging optical system 51 of each of the exposure heads 166 is movably provided so as to be moved in the optical axis direction when exposure is resumed. Thereby, the beam diameter of the laser beam on the photosensitive material 150 can be changed. Therefor, the exposure image before exposure is stopped and the exposure image after exposure is resumed may be continuous near the exposure stop position in natural state.

When position shift is detected in the X, Y, and Z directions, exposure control may be performed in the X, Y, and Z directions at the same time. The exposure image before exposure is stopped and the exposure image after exposure is resumed may be continuous in more natural state.

When the exposure start position is reset to the upstream position of the position, in which exposure is stopped, by the predetermined amount in step 220, the exposure image after exposure is resumed may be formed so as to be overlapped on the exposure image before exposure is stopped to some extent. The exposure image before exposure is stopped and the exposure image after exposure is resumed may be continuous near the exposure stop position in natural state.

The processes in steps 210 and 212 are performed as described above. The processes in steps 200 to 212 and in steps 220 to 230 are repeated until the moving stage 152 is judged to reach the exposure end position in step 212.

When the current position of the moving stage 152 is judged to reach the exposure end position in step 212, the routine is moved to step 214 so as to stop the moving stage 152.

As described above, when relative position shift of the moving stage 152 and the exposure head 166 is detected, exposure by the exposure head 166 is stopped so as to return the relative position of the moving stage 152 and the exposure head 166 to the upstream position (exposure start side) of the stop position, in which exposure by the exposure head 166 is stopped. Thereafter, exposure is resumed from the position in a predetermined range including the stop position. As compared with the exposure device having the vibration removing device, the exposure device of the invention can prevent cost increase and deterioration of image quality due to abnormal occurrence such as vibration.

Exposure is controlled so as to continue from the already exposed image when exposure is resumed after exposure is stopped. The exposure image before exposure is stopped and the exposure image after exposure is resumed may be continuous near the exposure stop position in natural state.

In the above exemplary embodiment, when the amount of relative position shift of the moving stage 152 and the exposure head 166 is the allowance value or more, exposure by the exposure head 166 is stopped so as to return the moving stage 152 and resume exposure. However, the invention is not limited to the above. When the rate of change of the position of the moving stage 152 is the predetermined value or more, exposure by the exposure head 166 may be stopped so as to return the moving stage 152 and resume exposure. In place of the position measurement unit 20, an acceleration sensor may be provided. When the acceleration of the moving stage 152 during movement is the predetermined value or more, exposure by the exposure head 166 may be stopped so as to return the moving stage 152 and resume exposure. In either case, deterioration of image quality due to disturbance such as vibration can be prevented.

When an error occurs in exposure image data, exposure by the exposure head 166 may be stopped so as to return the moving stage 152 and resume exposure. When data is output from the image data creation unit 11 via the image buffer 12 to the DMD driver 13, a parity bit is added to a signal to be transmitted so as to perform parity check on the receiving side. It may be judged whether or not an error occurs in image data transmitted. The transmission error detection of the image data is not limited to the above and other check methods may be used, as needed.

In the above exemplary embodiment, when exposure is stopped once and exposure is resumed, rotation of the parallel plate provided to the exposure head 166 is controlled (the direction of the laser beam is controlled) in such a manner that the exposure image before exposure is stopped and the exposure image after exposure is resumed in the X direction are continuous without being shifted near the exposure stop position. The invention is not limited to the above and image data when being exposed may be corrected.

In detail, the image data creation unit 11 shifts exposure image data in the X direction by the amount of displacement in the X direction. As shown in FIG. 12, the shifted exposure image data is split into split exposure image data for each of the exposure heads 166 so as to store the split data in the image buffer 12. The data processing unit of the DMD driver 13 generates the control signal according to the corresponding split exposure image data for each of the exposure heads 166. The mirror drive controlling unit of the DMD driver 13 on-off controls each of the micro-mirrors of the DMD 50 for each of the exposure heads 166 according to the generated control signal.

When image data is corrected, exposure image data need to be recreated by returning the routine. Therefore, the processing may be troublesome. Even in such control, exposure may be resumed after shifting by the amount of displacement in the X direction. The exposure image before exposure is stopped and the exposure image after exposure is resumed can be continuous in natural state.

In this case, when exposure shifted by the amount of displacement is continued, exposure is performed as shown in FIG. 14 (middle). When the amount of shift is gently and gradually decreased, exposure can be performed as shown in FIG. 14 (right).

The exposure image data before being split is shifted in the above. However, the split exposure image data obtained by splitting the exposure image data for each of the exposure heads 166 may be shifted.

In the above exemplary embodiment, regarding position shift in the Y direction, the reset timing of each of the exposure heads 166 is controlled so that the exposure image before exposure is stopped and the exposure image after exposure is resumed are continuous in natural state. However, the present invention is not limited to the above and as described above, the image data when being exposed may be corrected. The above-described process may be performed in the Y direction. Therefore, the exposure image before exposure is stopped and the exposure image after exposure is resumed can be continuous in natural state.

In the above exemplary embodiment, the exposure device having the DMD as the spatial light modulation element is described. However, besides such reflection type spatial light modulation element, a transmission type spatial light modulation element may be used.

In the above exemplary embodiment, the exposure device of the so-called flat bed type is taken as an example. However, the exposure device may be of the so-called outer drum type having a drum with the photosensitive material wound therearound.

The exposure device may be preferably used for application of exposure of a dry film resist (DFR) in the manufacturing process of a printed wiring board (PWB), formation of a color filter in the manufacturing process of a liquid crystal display (LCD), exposure of the DFR in the manufacturing process of a TFT, exposure of the DFR in the manufacturing process of a plasma display panel (PDP), and the like.

In the above exemplary embodiment, the exposure device having the spatial light modulation element is described. However, the present invention is not limited to the above and is applicable to an ink jet printer.

1-8. (canceled)

9. A drawing device comprising:
a drawing component that includes a stage and a drawing head, arranged so as to be relatively movable with respect to each other, the drawing component drawing with the drawing head on a recording medium supported by the stage;
a moving component that relatively moves the stage and the drawing head;
a position detection component that detects a relative position of the stage and the drawing head;
an error detection component that detects an abnormal state, in which abnormal drawing is performed on the recording medium; and
a controller that, when the abnormal state is detected, controls the moving component so as to stop drawing with the drawing head and to return the relative position of the stage and the drawing head from the stop position, in which drawing with the drawing head is stopped, to a position on the drawing start side, the controller then controlling the drawing component so as to resume drawing from a position within a predetermined range including the stop position.

10. The drawing device of claim 9, wherein the abnormal state is at least one of a state in which the relative position detected by the position detection component is a first predetermined value or more, a state in which the rate of change of the relative position detected by the position detection component is a second predetermined value or more, a state in which an acceleration acting on the drawing component is a third predetermined value or more, and/or a state in which an error occurs in image data when being drawn.

11. The drawing device of claim 9, wherein the controller controls the moving component so as to return the relative position of the stage and the drawing head from the stop position to the position of the drawing start side and then controls the drawing component so as to resume drawing from a position within a predetermined range including the stop position and so as to draw a continuation from an image that is being drawn on the recording medium.

12. The drawing device of claim 9, wherein the drawing head is an exposure head having a spatial light modulation element or is a droplet discharge head that discharges a droplet.

13. An exposure device comprising:
an exposure component that includes a stage and an exposure head having a spatial light modulation element, the stage and the exposure head being arranged so as to be relatively movable with respect to each other, and the exposure component exposes with the exposure head a recording medium supported by the stage;
a moving component that relatively moves the stage and the exposure head;
a position detection component that detects a relative position of the stage and the exposure head;
an error detection component that detects an abnormal state in which abnormal exposure is performed on the recording medium; and
a controller that, when the abnormal state is detected, controls the moving component so as to stop exposure by the exposure head and to return the relative position of the stage and the exposure head from the stop position, in which exposure by the exposure head is stopped, to a position on the exposure start side, the controller then controlling the exposure component so as to resume exposure from a position within a predetermined range including the stop position.

14. The exposure device of claim 13, wherein the abnormal state is at least one of a state in which the relative position detected by the position detection component is a first predetermined value or more, a state in which the rate of change of the relative position detected by the position detection component is a second predetermined value or more, a state in which an acceleration acting on the exposure component is a third predetermined value or more, and a state in which an error occurs in image data when being exposed.

15. The exposure device of claim 13, wherein the controller controls the moving component so as to return the relative position of the stage and the exposure head from the stop position to the position of the exposure start side and then controls the exposure component so as to resume exposure from the position within a predetermined range including the stop position and so as to perform exposure as a continuation from an image that is being exposed on the recording medium.

16. A drawing method that draws with a drawing head on a recording medium supported by a stage, the drawing method comprising:
relatively moving the stage and the drawing head;
detecting a relative position of the stage and the drawing head;
detecting an abnormal state in which abnormal drawing is performed on the recording medium; and
when the abnormal state is detected, controlling so as to stop drawing with the drawing head and to return the relative position of the stage and the drawing head from the stop position, in which drawing with the drawing head is stopped, to a position on the drawing start side, and then controlling so as to resume drawing from a position within a predetermined range including the stop position.
